(19) United States
(12) Patent Application Publication
(10) Pub. No.: US 2009/0165331 A1
(43) Pub. Date: Jul. 2, 2009

(54) METHOD OF CONTROLLING HEAT IN DRYER HAVING INTAKE DUCT WITH BUILTIN HEATER

(75) Inventor: Chang Hoo Kim, Gyeyang-gu (KR)

Correspondence Address: OCCHIUTI ROHLICEK & TSAO, LLP, 10 FAWCETT STREET, CAMBRIDGE, MA, 02138, US

(73) Assignee: Daewoo Electronics Corporation, Seoul (KR)

(21) Appl. No.: 12/345,196

(22) Filed: Dec. 29, 2008

(30) Foreign Application Priority Data
Dec. 27, 2007 (KR) 10-2007-0139510

(51) Int. Cl. F26B 3/02

(52) U.S. Cl. 34/493

(57) ABSTRACT

A method of controlling a heat in a dryer having an intake duct with a builtin heater operates a plurality of heaters independently of each other depending on a range of drying temperature and also controls the heater with temperature control or time control depending on the range of the drying temperature, thereby reducing difference in a temperature between an intake port of hot wind and a discharge port and allowing efficient heater control by a discharge temperature at the discharge port.

### CROSS-REFERENCE TO RELATED APPLICATIONS

The present application claims priority to Korean patent application number 10-2007-0139510, filed on Dec. 27, 2007, which is incorporated by reference in its entirety.

### BACKGROUND OF THE INVENTION

The present invention relates to a method of controlling a heat in a dryer having an intake duct with a builtin heater, and more particularly, to a method of controlling a heat in a dryer having an intake duct with a builtin heater, which operates a plurality of heaters independently of each other depending on a range of drying temperature and also controls the heater with temperature control or time control depending on the range of the drying temperature, thereby reducing difference in a temperature between an intake port of hot wind and a discharge port and allowing efficient heater control by a discharge temperature at the discharge port.

FIG. 1 is a schematic diagram showing a flow path of a conventional dryer and FIG. 2 is a partially broken perspective view of the conventional dryer.

Referring to FIGS. 1 and 2, the conventional dryer includes a cabinet 2 which forms an external appearance of the dryer and provided with an opening formed in front thereof and through which laundries to be dried are put into the dryer, a drum 12 which is rotatably mounted inside the cabinet 2 to accommodate the laundries to be dried and has opened front and rear portions for allowing air to pass therethrough, a heater 18 which is disposed inside the cabinet 2 to heat the air sucked into the cabinet 2, an intake duct 20 which guides the heated air passed through the heater 18 to the rear of the drum 12, an exhaust unit 22 which exhausts the air polluted by drying the laundries to the outside of the cabinet 2, a blower fan (not shown) which is installed in the exhaust unit 22, and a motor (not shown) and a belt 40 which drive the drum 12 and the blow fan to be rotated.

A lifter 11 is mounted on an inner peripheral surface of the drum 12 to lift up and drop the laundries to be dried.

The exhaust unit 22 includes a lint duct 25 which receives the air from the drum 12 to filter foreign substances from the air by a filter 24 mounted therein, a fan housing 26 which communicates with the lint duct 25 and houses the blower fan and an exhaust duct 27 which communicates with the fan housing 26 at one end thereof and extends to the outside of the cabinet 2 at the other end.

Operation of the conventional dryer having the above described structure is will be described.

First, by operating the dryer after putting the laundries to be dried into the drum 12 and closing a door, the motor is driven to rotate the drum 12 and the blower fan and the heater 18 is operated together.

At this time, as the drum 12 is rotated, the laundries to be dried in the drum 12 are lifted up and dropped by the lifter 11. External air is sucked in the heater 18, heated to air with high temperature and low humidity and then supplied to the inside of the drum 12 through the intake duct 20.

The air with high temperature and low humidity supplied to the inside of the drum 12 is brought into direct contact with the laundries to dry the laundries and changed to air with low temperature and high humidity. While drying the laundries, the air is moved toward the front of the drum 12 and then discharged to the outside of the dryer through the exhaust unit 22.

In such dryer, a separate duct extended from the intake duct is disposed in an inside of the cabinet and the heater is installed in an inside this separate duct. Therefore, there is a problem that heat loss occurs during the air heated by the heater is flowed into the drum since a distance between the heater and the drum cannot be shortened below a certain distance. Also, there is a problem that malfunction and damage of the dryer due to overheat of the motor may occur since the motor apt to be overheated and the heater are disposed adjacent to each other and thus the inside of the cabinet is apt to be excessively overheated.

Accordingly, in order to improve the problems, as shown in FIG. 3, the heater is installed in an inside of an intake duct 70 disposed at an outside of the cabinet 50 to shorten the distance between the heater 74 and the drum 60 so that the flow path of the heated air is shortened to reduce the heat loss and the excessive overheat can be prevented. Therefore, it is possible to restrict the loss of thermal energy occurred while the air heated above a certain temperature by the heater flows along the intake duct 70 and thus enhance the efficiency of the dryer.

Also, since the heater 74 is disposed in a separate space from the motor 90 which is apt to be overheated as the heater is disposed at the outside of the cabinet 50, it is possible to prevent the inside of the cabinet 50 from being excessively overheated and thus prevent the malfunction and damage of the dryer due to the overheat of the motor 90.

### SUMMARY OF THE INVENTION

However, as the vertical heater 74 is installed in the inside of the intake duct 70 to shorten the distance between the heater 74 and the drum 60 so as to shorten the flow path of the heated air to reduce the heat loss and prevent the excessive overheat as described above, there is a problem that temperature control is difficult in a case of controlling ON/OFF of the heater by measuring a temperature of discharge air discharged from the drum 60. That is to say, in the case that the ON/OFF of the heater is controlled depending on the temperature of the discharge air, the heater may be continuously operated as the temperature of the discharge air is low even though a temperature of intake air is high due to great difference between a temperature of the intake air and a temperature of the discharge air and this may cause damage of clothes.

Embodiments of the present invention are directed to a method of controlling a heat in a dryer having an intake duct with a builtin heater, which operates a plurality of heaters independently of each other depending on a range of drying temperature and also controls the heater with temperature control or time control depending on the range of the drying temperature, thereby reducing difference in a temperature between an intake port of hot wind and a discharge port and allowing efficient heater control by a discharge temperature at the discharge port.

In one embodiment, a method of controlling a heater in a dryer having an intake duct with a builtin heater, provided with a plurality of the heaters installed in an inside of the intake duct and heat air supplied to an inside of a drum, selectively performs temperature control and time control depending on selected ranges of a drying temperature, and the temperature control is performed by any one heater of a plurality of heaters and the time control is performed by controlling operation time of one heater of the plurality of the heaters in a state that the other heater is being operated.

The ranges of the drying temperature in which the temperature control is performed include a low-temperature dry and an ultra low-temperature dry.

In the low-temperature dry, the heater is operated at a temperature of discharge air of 40° C. and stopped at the temperature of the discharge air of 47° C.

In the ultra low-temperature dry, the heater is operated at a temperature of discharge air of 33° C. and stopped at the temperature of the discharge air of 40° C.

When the temperature control is performed, a maximum value of a temperature of the intake air is 160° C. upon the low-temperature dry and 140° C. upon the ultra low-temperature dry.

The ranges of the drying temperature in which the time control is performed include a middle-temperature dry, a middle high-temperature dry and a high-temperature dry.

The time control is performed separately on an initial period in which variation in a temperature of discharge air is uniform, a middle period in which the variation in the temperature of the discharge air is sharply arisen and the last period in which the variation in the temperature of the discharge air uniform after a humidity sensor is saturated.

The initial period is a time period from beginning of the operation to 1 minute 40 second, the middle period is a time period from 1 minute 40 second to 50 minute and the last period is a time period after the 50 minute.

In the middle-temperature dry, the heater is operated for 1 minute and 20 seconds and stopped for 20 seconds in the initial period, repeats 20 seconds of the operation and 20 seconds of stop in the middle period and repeats 10 seconds of the operation and 20 seconds of stop in the last period.

In the middle high-temperature dry, the heater is operated for 1 minute and 20 seconds and stopped for 20 seconds in the initial period, repeats 30 seconds of the operation and 20 seconds of stop in the middle period and repeats 20 seconds of the operation and 20 seconds of stop in the last period.

In the high-temperature dry, the heater is operated for 1 minute and 20 seconds and stopped for 20 seconds in the initial period, repeats 30 seconds of the operation and 10 seconds of stop in the middle period and repeats 20 seconds of the operation and 10 seconds of stop in the last period.

When the time control is performed, a maximum value of a temperature of the intake air is 190° C. upon the middle-temperature dry, 210° C. upon the middle high-temperature dry and 230° C. upon the high-temperature dry.

According to the present invention, it is possible to operate a plurality of heaters independently of each other depending on a range of drying temperature and also control the heater with temperature control or time control depending on the range of the drying temperature, thereby reducing difference in a temperature between an intake port of hot wind and a discharge port and allowing efficient heater control by a discharge temperature at the discharge port.

### BRIEF DESCRIPTION OF THE DRAWINGS

FIG. 1 is a schematic diagram showing a flow path of a conventional dryer.

FIG. 2 is a partially broken perspective view of the conventional dryer.

FIG. 3 is a rear side perspective view illustrating a dryer provided with an intake duct with a builtin heater to which a method of controlling a heater in accordance with an embodiment of the present invention is applied.

FIG. 4 and FIG. 5 are a flowchart illustrating a method of controlling a heater of a dryer provided with an intake duct with a builtin heater in accordance with an embodiment of the present invention.

FIG. 6 is a graph showing change of a temperature of discharge air, with time, in a dryer provided with an intake duct with a builtin heater in accordance with an embodiment of the present invention.

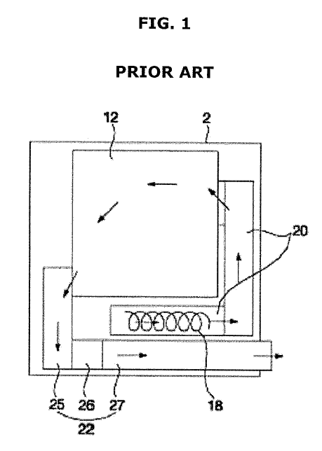

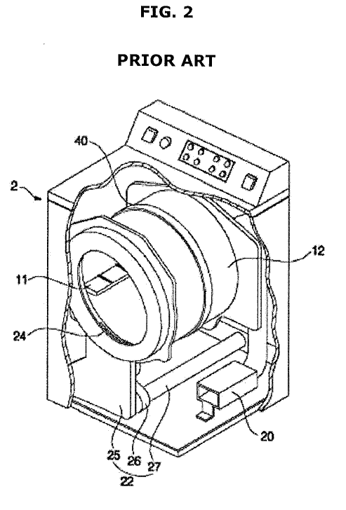

### DESCRIPTION OF SPECIFIC EMBODIMENTS

Hereinafter, an exemplary embodiment of the present invention will be described with reference to accompanying drawings.

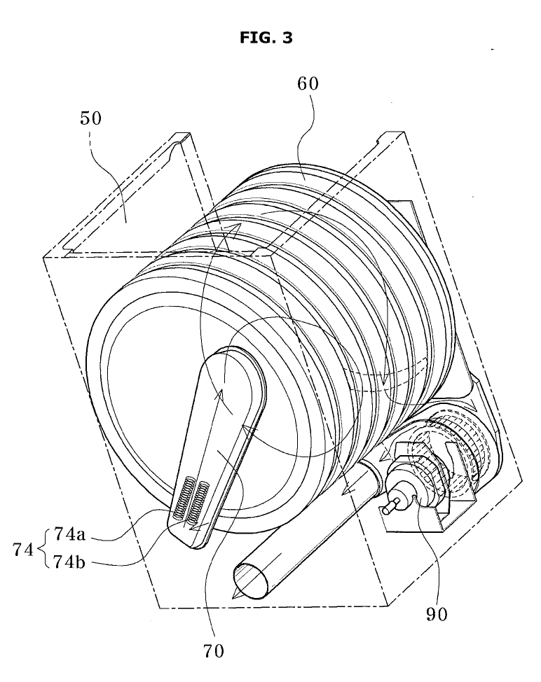

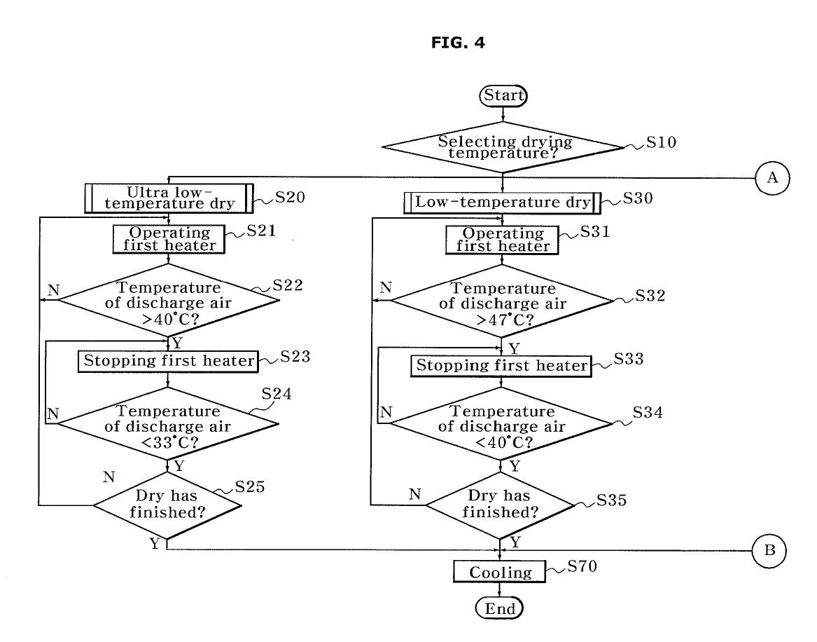

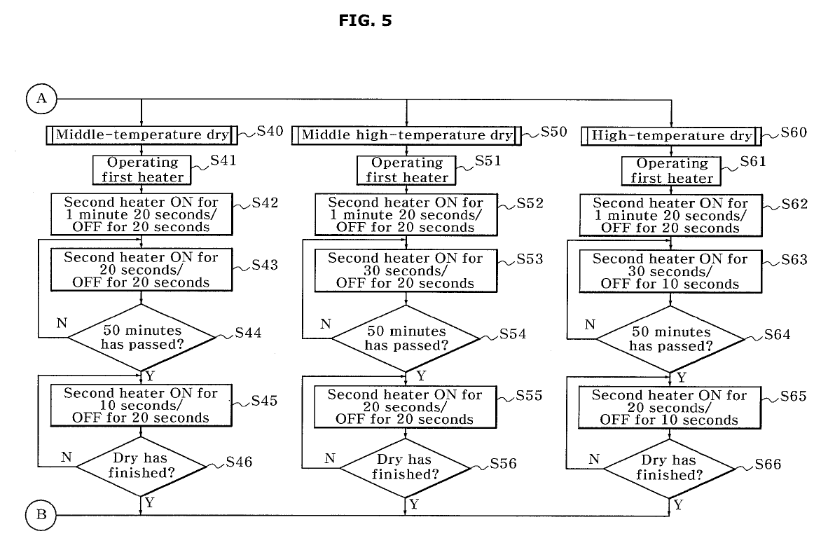

FIG. 3 is a rear side perspective view illustrating a dryer provided with an intake duct with a builtin heater to which a method of controlling a heater in accordance with an embodiment of the present invention is applied and FIG. 4 and FIG. 5 are a flowchart illustrating a method of controlling a heater of a dryer provided with an intake duct with a builtin heater in accordance with an embodiment of the present invention.

First, after laundries are putted in a drum 60 of a gas laundry dryer and a door of the dryer is closed, a drying condition is inputted through a key inputting unit. [0037] As the drying condition, one of an ultra low-temperature dry (S20), a low-temperature dry (S30), a middle-temperature dry (S40), a middle high-temperature dry (S50) and a high temperature dry (S60) is selected (S10).

At this time, when the ultra low-temperature dry (S20) is selected, temperature control is performed by operating a first heater 74a alone of first and second heaters 74a, 74b (S21).

That is to say, operation of the first heater 74a is stopped when a temperature of discharge air exceeds 40° C. after the first heater 74a is operated, and the first heater 74a is operated again when the temperature of the discharge air drops below 30° C. (S22)(S23)(S24).

At this time, when a temperature of intake air exceeds 140° C., the operation of the first heater 74a is stopped.

As such, the dry process is carried out through the temperature control, and at the end of the dry process, a cooling process is carried out and the dry process is then finished (S25)(S70).

Next, when the low-temperature dry (S30) is selected, the temperature control is performed by operating the first heater 74a alone of the first and second heaters 74a, 74b (S31).

That is to say, the operation of the first heater 74a is stopped when the temperature of the discharge air exceeds 47° C. after the first heater 74a is operated, and the first heater 74a is operated again when the temperature of the discharge air drops below 40° C. (S32)(S33)(S34).

At this time, when the temperature of intake air exceeds 160° C., the operation of the first heater 74a is stopped.

As such, the dry process is carried out through the temperature control, and at the end of the dry process, the cooling process is carried out and the dry process is then finished (S35)(S70).

Next, when the middle-temperature dry (S40) is selected, the first heater 74a is first operated and a time control is then performed on the second heater 74b (S41).

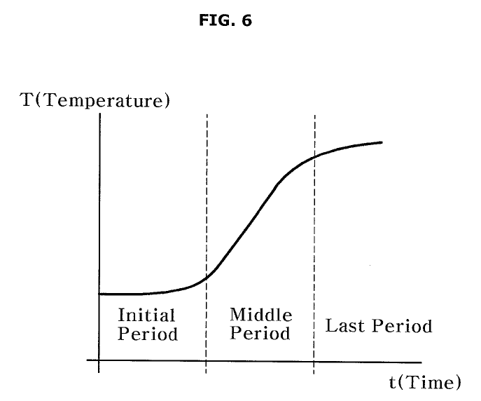

That is to say, as shown in FIG. 6, until 1 minute and 40 seconds after the beginning of the dry or an initial period in which variation in the temperature of the discharge air is uniform, the second heater 74b is operated for 1 minute and 20 seconds and then stopped for 20 seconds (S42).

After that, in a middle period until the lapse of 50 minutes in which the variation in the temperature of the discharge air is sharply arisen, the second heater 74b repeats 20 seconds of the operation and 20 seconds of stop (S43) (S44).

In the last period after the lapse of 50 minutes in which the variation in the temperature of the discharge air is uniform after a humidity sensor is saturated, the second heater 74b repeats 10 seconds of the operation and 20 seconds of stop (S45).

At this time, when the temperature of intake air exceeds 190° C., the operation of the first heater 74a and the second heater 74b is stopped.

As such, the dry process is carried out through the time control on the second heater 74b with first heater 74a being operated, and at the end of the dry process, the cooling process is carried out and the dry process is then finished (S46)(S70).

Next, when the middle high-temperature dry (S50) is selected, the first heater 74a is first operated and the time control is then performed on the second heater 74b (S51).

That is to say, as shown in FIG. 6, until 1 minute and 40 seconds after the beginning of the dry or the initial period in which variation in the temperature of the discharge air is uniform, the second heater 74b is operated for 1 minute and 20 seconds and then stopped for 20 seconds (S52).

After that, in the middle period until the lapse of 50 minutes in which the variation in the temperature of the discharge air is sharply arisen, the second heater 74b repeats 30 seconds of the operation and 20 seconds of stop (S53) (S54).

In the last period after the lapse of 50 minutes in which the variation in the temperature of the discharge air is uniform after a humidity sensor is saturated, the second heater 74b repeats 20 seconds of the operation and 20 seconds of stop (S55).

At this time, when the temperature of intake air exceeds 210° C., the operation of the first heater 74a and the second heater 74b is stopped.

As such, the dry process is carried out through the time control with respect to the second heater 74b with first heater 74a being operated, and at the end of the dry process, the cooling process is carried out and the dry process is then finished (S56)(S70).

Next, when the high-temperature dry (S60) is selected, the first heater 74a is first operated and the time control is then performed on the second heater 74b (S61).

That is to say, as shown in FIG. 6, until 1 minute and 40 seconds after the beginning of the dry or the initial period in which variation in the temperature of the discharge air is uniform, the second heater 74b is operated for 1 minute and 20 seconds and then stopped for 20 seconds (S62).

After that, in the middle period until the lapse of 50 minutes in which the variation in the temperature of the discharge air is sharply arisen, the second heater 74b repeats 30 seconds of the operation and 10 seconds of stop (S63) (S64).

In the last period after the lapse of 50 minutes in which the variation in the temperature of the discharge air is uniform after a humidity sensor is saturated, the second heater 74b repeats 20 seconds of the operation and 10 seconds of stop (S65).

At this time, when the temperature of intake air exceeds 230° C., the operation of the first heater 74a and the second heater 74b is stopped.

As such, the dry process is carried out through the time control with respect to the second heater 74b with first heater 74a being operated, and at the end of the dry process, the cooling process is carried out and the dry process is then finished (S66)(S70).

Although the present invention has been described with reference to the embodiments shown in the drawings, it should be understood that these embodiments are provided for illustrative purpose and that various equivalent modifications and alterations will be apparent to those skilled in the art without departing from the scope and spirit of this invention.

Therefore, the scope and spirit of the invention is limited only by the claims set forth herein as follows.

What is claimed is:

1. A method of controlling a heater in a dryer having an intake duct with a builtin heater provided with a plurality of the heaters installed in an inside of the intake duct and heat air supplied to an inside of a drum, wherein temperature control and time control are selectively performed depending on selected ranges of a drying temperature, and the temperature control is performed by any one heater of a plurality of heaters and the time control is performed by controlling operation time of one heater of the plurality of the heaters in a state that the other heater is being operated.

2. The method of claim 1, wherein the ranges of the drying temperature in which the temperature control is performed include a low-temperature dry and an ultra low-temperature dry.

3. The method of claim 2, wherein in the low-temperature dry, the heater is operated at a temperature of discharge air of 40° C. and stopped at the temperature of the discharge air of 47° C.

4. The method of claim 2, wherein in the ultra low-temperature dry, the heater is operated at a temperature of discharge air of 33° C. and stopped at the temperature of the discharge air of 40° C.

5. The method of claim 2, wherein when the temperature control is performed, a maximum value of a temperature of the intake air is 160° C. upon the low-temperature dry and 140° C. upon the ultra low-temperature dry.

6. The method of claim 1, wherein the ranges of the drying temperature in which the time control is performed include a middle-temperature dry, a middle high-temperature dry and a high-temperature dry.

7. The method of claim 6, wherein the time control is performed separately on an initial period in which variation in a temperature of discharge air is uniform, a middle period in which the variation in the temperature of the discharge air is sharply arisen and the last period in which the variation in the temperature of the discharge air uniform after a humidity sensor is saturated.

8. The method of claim 7, wherein the initial period is a time period from beginning of the operation to 1 minute 40 second, the middle period is a time period from 1 minute 40 second to 50 minute and the last period is a time period after the 50 minute.

9. The method of claim 7, wherein in the middle-temperature dry, the heater is operated for 1 minute and 20 seconds and stopped for 20 seconds in the initial period, repeats 20 seconds of the operation and 20 seconds of stop in the middle period and repeats 10 seconds of the operation and 20 seconds of stop in the last period.

10. The method of claim 7, wherein in the middle high-temperature dry, the heater is operated for 1 minute and 20 seconds and stopped for 20 seconds in the initial period, repeats 30 seconds of the operation and 20 seconds of stop in the middle period and repeats 20 seconds of the operation and 20 seconds of stop in the last period.

11. The method of claim 7, wherein in the high-temperature dry, the heater is operated for 1 minute and 20 seconds and stopped for 20 seconds in the initial period, repeats 30 seconds of the operation and 10 seconds of stop in the middle period and repeats 20 seconds of the operation and 10 seconds of stop in the last period.

12. The method of claim 7, wherein when the time control is performed, a maximum value of a temperature of the intake air is 190° C. upon the middle-temperature dry, 210° C. upon the middle high-temperature dry and 230° C. upon the high-temperature dry.
